(19) United States
(12) Patent Application Publication
(10) Pub. No.: US 2012/0146872 A1
(43) Pub. Date: Jun. 14, 2012

(54) ANTENNA RADIATING ELEMENT

(76) Inventors: Sebastien Chainon, Lannion (FR); Jean-Pierre Harel, Lannion (FR); Aurélien Hilary, Lannion (FR)

(21) Appl. No.: 13/376,543

(22) PCT Filed: Jun. 10, 2010
(86) PCT No.: PCT/EP2010/058137

§ 371 Date: Feb. 20, 2012

(30) Foreign Application Priority Data
Jun. 11, 2009 (FR) 0902840

(51) Int. Cl. H01Q 19/24

(52) U.S. Cl. 343/818

(57) ABSTRACT

The object of the invention is an antenna radiating element comprising:
at least one dipole, comprising a base and arms, printed on one of the surfaces of a flat substrate with a high dielectric constant,
at least one conductive line feeding the dipole, printed onto the substrate, characterized in that at least one parasitic element is further printed on the same surface of the substrate as the dipole and is disposed above the dipole's arms.

The present invention pertains to the domain of telecommunications antennas transmitting radio waves in the hyperfrequency domain using radiating elements.

For mobile communication services such as GSM, DCS/PCS, UMTS, etc., radiating elements have been developed in various shapes. In particular, an element shaped of two dipoles crossing one another at a 45° orthogonal polarization, known as a “butterfly” element. These elements exhibit advantages in terms of radio performance, industrialization ability, cost, and robustness. That is why these elements are heavily used for applications below 2.5 GHz. For high-frequency bands in which very large restrictions are involved regarding the dimensions of the radiating elements and their manner of assembly, this type of element has shown its limits due to its size and mechanical properties.

This is why, for WIMAX antennas (frequency band 2.3-2.7 GHz and 3.3-3.8 GHz) for example, radiating elements printed on a dielectric substrate are used. The advantage of the solution is that it enables precise, repetitive manufacturing, and is usable for different frequency bands. However, these radiating elements exhibit insufficiencies with respect to bandwidth and beamwidth, notably in the horizontal plane, and particularly when the ground plane on which the radiating elements are placed is of limited size (less than the wavelength X₀ corresponding to the antenna's operating frequency). Particularly in order to satisfy the requirements related to the digital processing of the signal, the new services are more demanding in terms of bandwidth, require the highest possible gain, and very high levels of insulation between radiating elements in a more compact environment.

One solution for expanding the bandwidth of the radiating elements consists of optimizing their shape, which grants them broadband properties and better radiation pattern stability. The radiating element's environment has also been improved: improving the shape of the ground plane and the lateral walls, adding particular shapes so as to optimize the radiation pattern (stability, beamwidth, cross polarization level) and coupling pattern (between radiating elements or between columns of radiating elements).

However, the arrival of new services (multimedia, 4G telephony, 2-66 GHz broadband mobile access system), requiring multi-polarized operation within high-frequency bands and a greatly reduced environment, has shown the limits of the existing radiating elements, even those that benefit from an optimized shape. Nonetheless, user demand is putting pressure on high-directivity antennas with a large bandwidth. Besides mobile applications that require highly compact solutions that exhibit low coupling between elements whenever they comprise adjacent columns of radiating elements. These elements therefore need to be perfected from standpoints of accuracy, solidity, cost, and performance.

It is therefore a purpose of the present invention to propose an antenna improved over those of the prior art from standpoint of radio performance, reliability, and production cost.

It is another purpose of the invention to propose a very compact multi-polarized antenna (vertically, horizontally, or orthogonally ±45° whose coupling rate between adjacent radiating element is less, despite a reduced form factor.

The invention further proposes an antenna radiating element whose bandwidth is expanded and whose gain is increased compared to the known radiating elements of the prior art.

The invention also proposes a simple, easy-to-implement method for manufacturing antenna radiating elements.

The object of the present invention is an antenna comprising at least one antenna radiating element comprising

at least one dipole, comprising a base and arms, printed on one of the surfaces of a flat substrate with a high dielectric constant,

at least one conductive line, feeding the dipole, printed on the dipole's substrate,

at least one parasitic element printed onto the dipole's substrate, disposed parallel to the dipole's arms,

at least one parasitic element is disposed in a plane that is perpendicular to the plane of the substrate bearing the radiating element and parallel to the arms of the radiating element's dipole, the parasitic element being sandwiched between the rows of radiating elements.

Here, the term parasitic element refers to a conductive element, disposed above a dipole, which is not fed, neither directly, nor indirectly, by way of the dipole. It is often designated by the term “director”. An increase in gain and bandwidth is obtained by adding parasitic elements above the dipoles.

Particular attention is paid to the shape of the radiating element (arrangement of the dipole/parasitic element, curved or tapered shapes, fractal design of the dipole, for example) with respect to the broadband impedance and stability of the radiation pattern space for (optimized cross polarization, rejecting a frequency band, for example)

The radiating element is accurate enough to be used in the new telecommunication services that make use of high frequencies, in particular those above 2.5 GHz. In particular, the technique of printing elements on a flat substrate affords great liberty and new properties, particularly for applications to wireless antennas.

According to a first variant, the antenna comprises two crossed dipoles, respectively comprising two collinear arms, and at least one parasitic element associated with each dipole, the dipoles and the parasitic elements being printed on a substrate comprising orthogonal planes.

According to a second variant, the antenna's radiating elements are printed side-by-side on a common flat substrate so as to constitute a row.

According to one embodiment, the parasitic elements have a fractal pattern.

According to another embodiment, the radiating elements have a fractal pattern.

According to one embodiment, the antenna comprises at least two superimposed parasitic elements printed on the dipole's substrate parallel to the dipole's arms.

According to another embodiment, the antenna further comprises an interfering element disposed within a plane that is perpendicular to the plane of the substrate bearing the radiating element and parallel to the arms of the radiating element's dipole, the interfering element being sandwiched between the rows of radiating elements. The function of the interfering elements is to minimize the coupling between the radiating elements by introducing interferences in the electromagnetic field.

The invention enables the improvement of the antenna's radio performances, in particular improving the directivity, increasing the bandwidth, ability for multiband operation, and improving decoupling between adjacent columns of elements.

A further object of the invention is a method for manufacturing a radiating element of that antenna comprising at least one step of printing at least one dipole and at least one parasitic element on the same flat dielectric substrate, and a step of printing at least one interfering element on a flat dielectric substrate perpendicular to the plane of the substrate bearing the radiating element.

One benefit of the manufacturing method is that it is simple and easy to implement, making it possible to obtain a solid, inexpensive radiating element. The radiating elements manufactured in this manner enable the assembly of more robust and more accurate antennas, despite the number of parasitic elements, and the addition of interfering elements.

Other characteristics and advantages of the invention will become apparent through the following example embodiments, which are non-limiting and given for purely illustrative purposes, and in the attached drawing, in which:

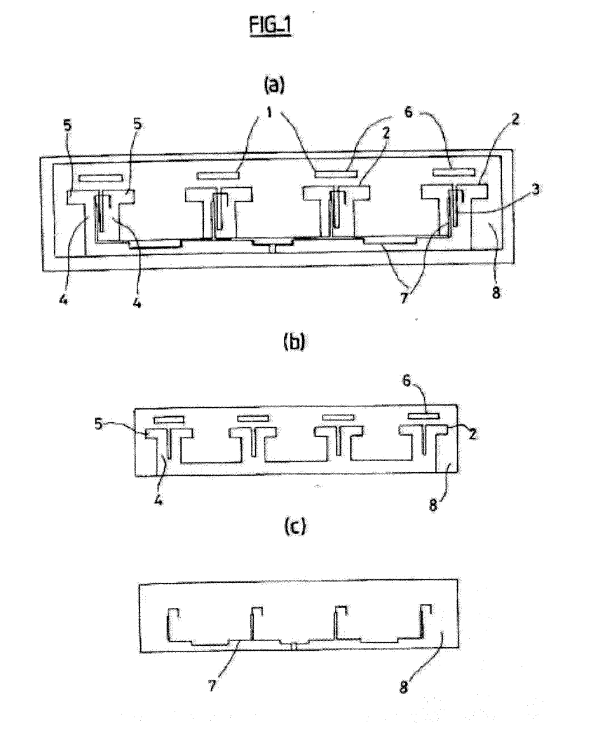

FIGS. 1a, 1b and 1c represent a schematic front view of a vertical-polarized radiating element comprising a parasitic element,

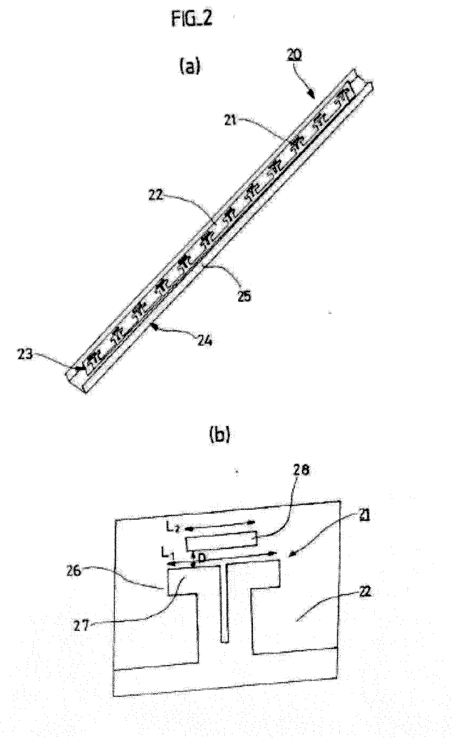

FIG. 2a shows a partial view of antenna comprising radiating elements analogous to those in FIGS. 1a-1c, and FIG. 2b is a detailed view of one of those elements,

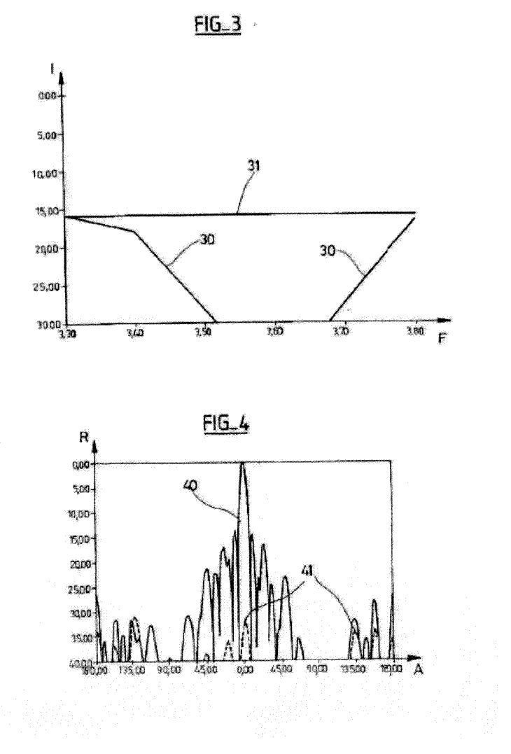

FIG. 3 shows the reflection coefficient I in decibels on the y-axis, as a function of the impedance F in ohms on the x-axis,

FIG. 4 is the radiation pattern in the vertical plane of the antenna in FIG. 2,

FIG. 5 is the radiation pattern in the horizontal plane of the antenna in FIG. 2,

In FIGS. 4 and 5, the intensity of the radiation R in dBi is given on the Y-axis, and the radiation angle A of the plane in question is given in degrees on the X-axis.

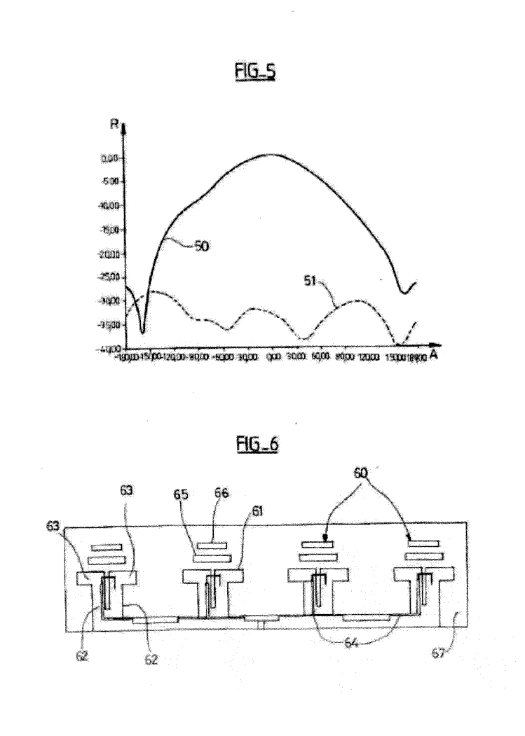

FIG. 6 depicts a schematic front view of a radiating element comprising multiple parasitic elements,

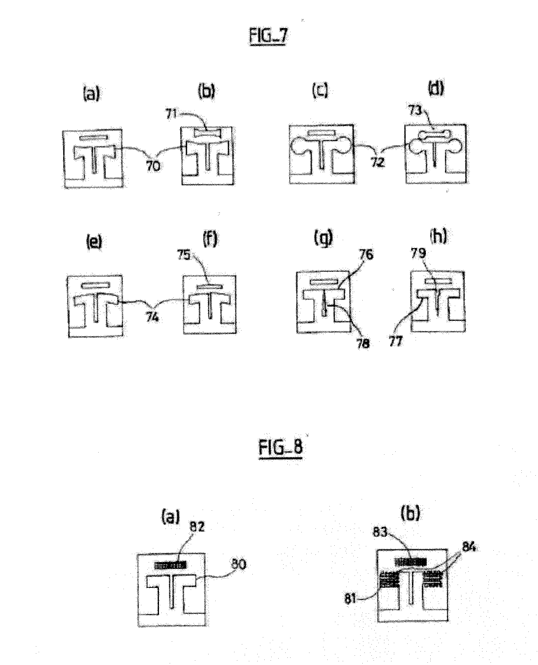

FIGS. 7a-7h are schematic front views of various vertical-polarized radiating elements comprising a parasitic element,

FIGS. 8a and 8b are schematic front views of a vertical-polarized radiating element comprising a parasitic element with a fractal shape,

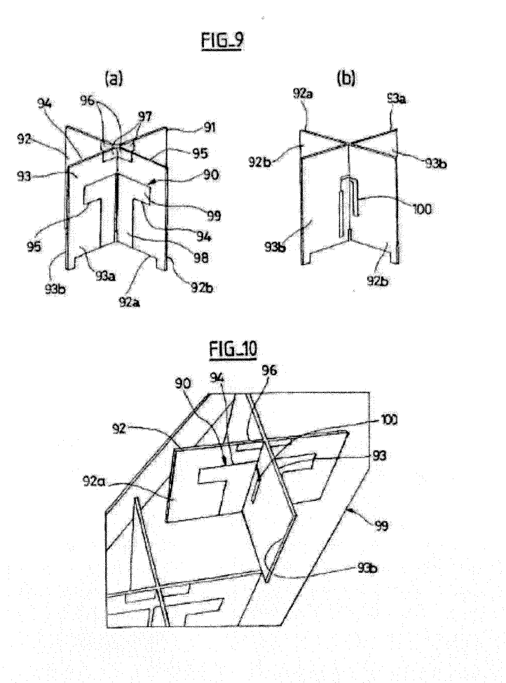

FIGS. 9a and 9b are a schematic front and rear view of a cross-polarized radiating element comprising a parasitic element.

FIG. 10 shows a partial view of an antenna comprising cross-polarized radiating elements analogous to those in FIGS. 9a and 9b,

FIG. 11 depicts a perspective schematic view of an array of cross-polarized radiating elements comprising dipoles and parasitic elements with a fractal shape,

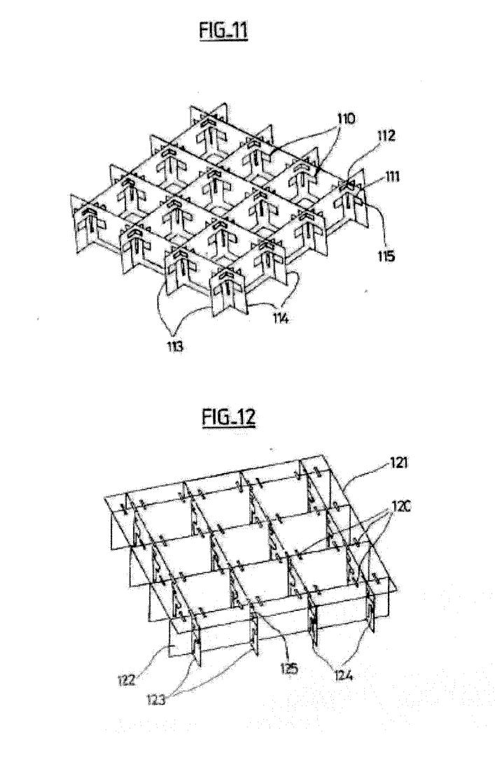

FIG. 12 depicts a perspective schematic view of an array of cross-polarized radiating elements comprising parasitic elements spaced apart according to a first variant,

FIG. 13 depicts a perspective schematic view of an array of radiating elements comprising parasitic elements spaced apart according to a second variant,

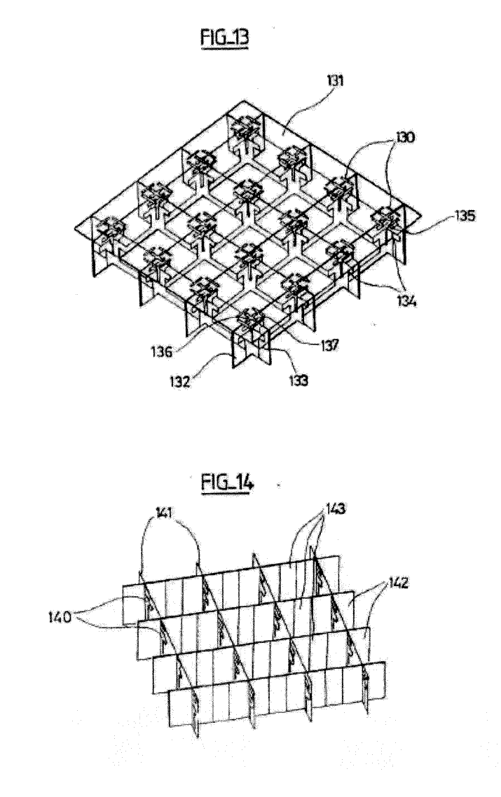

FIG. 14 depicts a perspective schematic view of an array of flat vertical-polarized radiating elements wherein the interfering elements are placed between the rows of radiating elements according to a first variant.

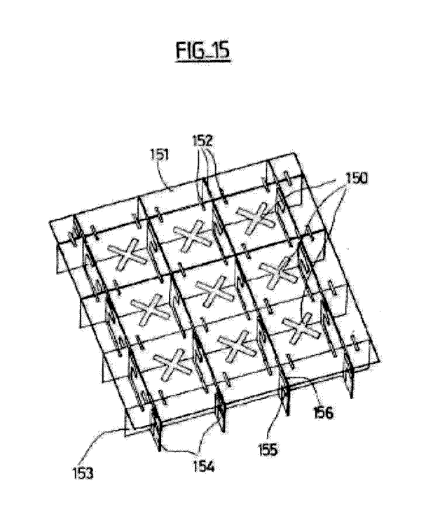

FIG. 15 depicts a perspective schematic view of an embodiment of an array of flat vertical-polarized radiating elements wherein interfering elements are placed between the rows of radiating elements according to a second variant.

FIGS. 1a to 1c depict one embodiment of a flat alignment of vertical-polarized radiating elements 1. The radiating element 1 comprises a half-wave dipole 2 made up of two half-dipoles separated by a slot 3 each comprising a base 4 supporting an arm 5. The two arms 5 of the dipole 2 define a radiating line. In order to increase the gain and bandwidth, this radiating line is topped with another radiating line formed by a parasitic or “director” element 6, which is not electrically connected with the dipole 2. The dipole 2 is fed by a conductive line 7 connected to a balun, which is not depicted. The dipole 2, which is a stripline dipole, and the parasitic element 6 are printed on one of the surfaces (FIG. 1b) of a substrate 8 with a low dielectric constant εᵣᵣ (1<εᵣᵣ<6), such as, for example, a glass and Teflon plate with the product code “TLX-08” from the company “TACONIC”. The conductive line 7 is printed on the opposite surface (FIG. 1c) of the dielectric substrate 8.

FIGS. 2a and 2b depict part of an antenna 20 comprising a row of twelve radiating elements 21 of the type depicted in FIGS. 1a-1c. The radiating elements 21 are printed on a substrate 22 forming a printed circuit board (PCB) 23. The printed circuit board 23 is fastened onto a reflector 24, forming a U-shaped ground plan with a reduced surface area. In the present situation, the distance between the side edges 25, forming the walls of the reflector, is, for example, 0.5kλ₀, where kλ₀ is the wavelength of the antenna's operating frequency, for a very compact antenna 20. An enlarged depiction of one radiating element 21 is given in FIG. 2b. Each radiating element 21 comprises a dipole 26 whose arms 27, which are on the same length as one another, have a total length L₁. The arms 27 of the dipole 26, with the length are topped by a parasitic element 28 with the length L2 less than the length L₁. The ratio R of the lengths L₂/Lᵢ is equal here, for example, to 0.65. The distance D between the dipole 26 and the parasitic element 28 is between 0.07 and 0.11 of the guided wavelength 2, such that λᵣ=λ₀/√εᵣ where εᵣ is the dielectric constant of the substrate that is used and λ₀ is the wavelength of the antenna's operating frequency. In the present situation, the combination of a dipole 26 and a parasitic element 28 makes it possible to obtain improved radio performance, in particular the width of the bandwidth.

The reflection coefficient I in decibels is depicted by the curve 30 in FIG. 3 as a function of the impedance F in ohms. In the 3.3-3.8 GHz frequency band of WIMAX applications (14% of the frequency band's width), the antenna must operate with a stationary wave ratio ROS of 1.37, which corresponds to the baseline 31 shown as a solid line. The antenna's operation in the given frequency range is satisfactory, because the curve 30 is located fully beneath the baseline 31, and more particularly in the 3.51-3.696 Hz frequency zone.

In FIG. 4, the vertical radio radiation pattern (curve 40, shown as a solid line) shows the intensity of the radiation R in the vertical plane in dBi as a function of the radiation angle A in degrees. A beamwidth at medium-power (R=−3 dBi) in the main polarization, equal to 6 degrees is achieved in the vertical plane. In the cross-polarization, the curve 41 (shown as a dashed line) is at a very low level, a level about 33 dB less than what is observed in the main polarization.

to The horizontal radio radiation pattern (curve 50 shown as a solid line) is depicted in FIG. 5. The intensity of the radiation R in the horizontal plane in dBi is given as a function of the radiation angle A in degrees. Despite the low surface area of the ground plane 24 of the antenna 20, the beamwidth is close to 90° in the horizontal plane. In the cross-polarization, the curve 51 (shown as a dashed line) is at a very low level, a level about 33 dB less than what is observed in the main polarization.

FIG. 6 depicts another embodiment of an alignment of vertical-polarized radiating elements 60. The radiating element 60 comprises a half-wave dipole 61, made up of two separate dipoles each comprising a base 62 supporting an arm 63, fed by a conductive line 64. The two arms 63 of the dipoles 61 define a radiating line. In order to increase the gain and bandwidth, this radiating line is topped with two other radiating lines respectively formed by a lower parasitic element 65 and by an upper parasitic element 66. The superimposed parasitic elements 65, 66 are not electrically linked to one another, nor are they connected to the dipole 61. The radiating element 60 is printed onto a substrate 67 that is a dielectric substrate.

FIGS. 7a to 7h give examples of shapes that may be taken by a broadband radiating element, comprising a dipole topped by a parasitic element, printed on a dielectric substrate. For each example, a dipole topped by a single parasitic element has been depicted. Naturally, these shapes are also valid for radiating elements that comprise two or more parasitic elements.

FIGS. 7a and 7b show a radiating element 70 whose dipoles have a flared shape, known as a “bowtie”; in FIG. 7b, the parasitic element 71 also adopts this shape.

FIGS. 7c and 7d show a radiating element 72 whose dipoles have a shape swollen at the ends, known as a “dogbone”; in FIG. 7d, the parasitic element 73 also adopts this shape.

FIGS. 7e and 7f show a radiating element 74 whose dipoles have a curved shape at the ends, known as “wings”; in FIG. 7f, the parasitic element 75 also adopts this shape.

FIGS. 7g and 7h show radiating elements 76, 77 having dipoles whose base is separated into two parts by a tapered slot 78, 79 which, in the two figures, are in opposite directions. This sort of tapered slot is said to be multi-sections, as the slots 78, 79 are formed of multiple sections with different widths.

The printing technique on a substrate also makes it possible to produce radiating elements 80, 81 based on a fractal pattern as shown in FIG. 8, in order to improve the bandwidth and multifrequency behavior. For example, the parasitic element 82 of the radiating element 80 adopts a fractal pattern. The parasitic element 83 of the radiating element 81 adopts a fractal pattern, and the two arms 84 also adopt a fractal pattern, for example. It becomes possible to easily obtain any sort of shape for radiating elements in two dimensions. The use of a fractal pattern is particularly advantageous in broadband or multiband applications.

FIG. 9 schematically depicts a radiating element 90 printed on a substrate 91 made up of two orthogonal planes 92, 93. The radiating element 90 comprises two dipoles 94, 95 crossing one another at a ±45° orthogonal polarization. The intersection of the dipoles 94, 95 at the point of their respective slots coincide with the intersection of the planes 92, 93 of the substrate 91. The dipoles 94, 95 are each topped with a parasitic element 96, 97.

A dipole 94, 95 comprises a colinear conductive base 98 and arm 99, both printed onto a surface 92a, 93a of a plane 92, 93 of the substrate 91. The dipole 94, 95 is fed by a conductive line 100 printed onto the opposite surface 92b, 93b of the plane 92.

The radiating element 90 installed on the reflector 99 of an antenna is depicted in perspective view in FIG. 10. It is therefore possible to easily obtain any sort of shape for radiating elements in three dimensions.

FIG. 11 depicts an array of cross-polarized radiating elements. Each radiating element 110 comprises two dipoles 111, two parasitic elements 112, and two conductive lines to feed the dipoles (not shown). Each orthogonal plane 113, 114 of the substrates is extended so as to serve as a substrate for printing the adjacent radiating element. The dipoles 111 comprise arms 115 constructed using a fractal pattern. The parasitic element 112 placed above the dipoles 111 is also constructed based on a fractal pattern. It is therefore possible to easily and flexibly obtain all sorts of configurations that associate radiating elements supported in three dimensions. Such an assembly exhibits the advantage of good mechanical resistance, because the planes are embedded within one another.

A particularly advantageous configuration for reducing the beamwidth in the horizontal plane is depicted in FIG. 12. Additional parasitic elements 120 are added in a horizontal plane 121 placed above the substrate's orthogonal planes 122, 123, parallel to the dipoles' arms. The dipoles 124 topped with a parasitic element 125 are printed on the substrate's parallel planes 123 in order to form rows of parallel dipoles 124. We note, in particular, the presence of additional parasitic elements 120 on either side of the vertical plane 123 bearing the vertical plane 125 topping the radiating line formed by the dipoles 124. The horizontal plane 121 may particularly be a part made of plastic fastened onto the substrate 122, 123, and atop which the additional parasitic elements 120 had been printed. Naturally, additional parasitic elements 120, or directors, may adopt any of the shapes previously mentioned. The addition of the horizontal plane 121 additionally exhibits the advantage of making the array of radiating elements rigid, and contributing to the antenna's mechanical resistance.

FIG. 13 shows one particular form of embodiment of additional parasitic elements 130 for radiating elements with ±45° cross-polarization. Here, the parasitic elements 130 are in the form of a “cross potent”, and are disposed on a horizontal plane 131 above the intersection of the orthogonal planes 132, 133 of the dielectric substrate upon which are printed the dipoles 134 topped with a parasitic element 135. The main axes 136, 137 of the cross potent respectively coincide with the orthogonal planes 132, 133 of the dielectric substrate.

This printing technique on a dielectric substrate makes it possible to construct multiband antennas comprising radiating elements 140 aligned in parallel rows. In the example of FIG. 14, the radiating elements 140 are printed on parallel planes 141 of the substrate, forming rows. The planes 142 forming columns, perpendicular to the planes 141, bear interfering elements 143 whose purpose is to minimize the coupling between the parallel rows of radiating elements by introducing interference into the electromagnetic field. The interfering elements 143 are metallic, and are sandwiched into the dielectric substrate forming the columns within the plane 142. This configuration is particularly advantageous for systems requiring high insulation between the rows of elements, such as an MIMO application.

According to one variant depicted in FIG. 15, interfering elements 150, here in the shape of a cross, may be printed onto a horizontal plane 151 that also bears the parasitic elements 152. The horizontal plane 151 is disposed atop the intersection of the planes 153 forming columns and the orthogonal planes 154 forming rows of radiating elements printed onto the dielectric substrate, meaning the dipoles 155 topped by a parasitic element 156.

Naturally, the present invention is not limited to the described embodiments, but is, rather, subject to many variants accessible to the person skilled in the art without departing from the spirit of the invention. In particular, it is possible, without departing from the scope of the invention, to modify the radiating element's shape, or those of the dipoles and/or parasitic element. It may also be possible to use a dielectric substrate of different natures and shapes. Finally, it is also possible to envision any printing method compatible with radio frequency operation.

1. An antenna comprising at least one antenna radiating element comprising
at least one dipole, comprising a base and arms, printed on one of the surfaces of a flat substrate with a high dielectric constant,
at least one conductive line, feeding the dipole, printed on the dipole's substrate,
at least one parasitic element printed onto the dipole's substrate, disposed parallel to the dipole's arms,
wherein at least one parasitic element is disposed within a plane that is perpendicular to the plane of the substrate bearing the radiating element and parallel to the arms of the radiating element's dipole, the parasitic element being sandwiched between the rows of radiating elements.

2. An antenna according to claim 1, comprising two crossed dipoles, respectively comprising two co-linear arms, and at least one parasitic element associated with each dipole, the dipoles and the parasitic elements being printed onto a substrate comprising orthogonal planes.

3. An antenna according to claim 1, wherein the radiating elements are printed side-by-side on a shared, flat substrate so as to constitute a row.

4. An antenna according to claim 1, wherein the parasitic elements have a fractal pattern.

5. An antenna according to claim 1, wherein the radiating elements have a fractal pattern.

6. An antenna according to claim 1, comprising at least two superimposed parasitic elements printed onto the dipole's substrate parallel to the dipole's arms.

7. An antenna according to claim 1, further comprising at least one interfering element disposed within a plane that is perpendicular to the plane of the substrate bearing the radiating element and parallel to the arms of the radiating element's dipole, the interfering element being sandwiched between the rows of radiating elements.

8. A method of constructing a radiating element according to claim 1, comprising at least one step of printing at least one dipole and at least one parasitic element on the same flat dielectric substrate, and a step of printing at least one interfering element on a flat dielectric substrate perpendicular to the plane of the substrate bearing the radiating element.
